(19) United States
(12) Patent Application Publication
(10) Pub. No.: US 2014/0202139 A1
(43) Pub. Date: Jul. 24, 2014

(54) Hydrocarbon Delivery Apparatus

(71) Applicants: Baohua Qi, Columbus, IN (US); Mi Yan, Irvine, CA (US)

(72) Inventors: Baohua Qi, Columbus, IN (US); Mi Yan, Irvine, CA (US)

(21) Appl. No.: 14/157,526

(22) Filed: Jan. 17, 2014

Related U.S. Application Data
(60) Provisional application No. 61/753,933, filed on Jan. 18, 2013.

(51) Int. Cl. F01N 9/00; F17D 3/01

(52) U.S. Cl. CPC F01N 9/002; F17D 3/01
USPC 60/295; 137/605

(57) ABSTRACT

An apparatus for controlling hydrocarbon delivery in an exhaust gas processing system of an engine that includes a heat generating device and a DPF, comprising a fuel injector and a control manifold, which has a pressure chamber holding compressed air for separating hydrocarbon from exhaust gas, and is fluidly connected to the fuel injector, a fuel control solenoid valve for controlling hydrocarbon supply, a pressure sensor, and a volume changing device, which provides a linear relationship between its volume change and pressure change in the control manifold. With the volume changing device, a deterioration factor value indicative of performance change of the hydrocarbon delivery device can be calculated for compensating temperature control, calculating the hydrocarbon conversion efficiencies of the heat generating device and the DPF in the exhaust gas processing system, detecting failures and mal-functions in the exhaust gas processing system and the engine.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### FIELD OF THE INVENTION

This present application claims priority from U.S. provisional application No. 61/753,933 entitled Hydrocarbon Delivery Apparatus for an Exhaust Gas Processing System and filed on Jan. 18, 2013.

This invention relates to a method and apparatus for controlling hydrocarbon delivery in an exhaust gas processing system and diagnosing system anomalies, more particularly, to a method and apparatus for controlling hydrocarbon delivery rate in an exhaust gas processing system including a heat generating device and a diesel particulate filter in controlling a temperature in the exhaust gas processing system, and diagnosing anomalies in the exhaust gas processing system.

### BACKGROUND OF THE INVENTION

Exhaust gas emitted from engines have been identified as a major contributor to air pollution. To remove air pollutants in exhaust gas, an exhaust gas processing system is required, and a Diesel Particulate Filter (DPF) is normally used in trapping Particulate Matters (PM), which may include unburned hydrocarbon particles or soot and a small amount of other particles, such as metal oxide particles or ash. The PM particles accumulate in the DPF. Before the accumulation causes a high back pressure to the engine, a regeneration process is needed to remove the accumulated soot.

Typically, in a regeneration process, a heat generating device is used to boost exhaust gas temperature to a level that soot can be effectively oxidized by oxygen, which in a lean combustion engine can be provided by exhaust gas. Then the high temperature exhaust gas passes through the DPF and the accumulated soot therein is removed after being oxidized into carbon dioxide and water. The temperature control of exhaust gas is critical in regeneration, since too low temperature may cause ineffective soot oxidation, while too high temperature damages the DPF.

A variety of heat generating devices can be used for regenerating DPFs. Among them, fuel burners and Diesel Oxidation Catalyst (DOC) devices are broadly used. In a fuel burner, hydrocarbon is provided by a hydrocarbon delivery device, which injects hydrocarbon into a combustion chamber, while in a DOC apparatus, hydrocarbon can be either provided by an engine fuel system during post injection or injected directly into a catalyst with a hydrocarbon delivery device. Compared to post fuel injections, which may lead to dilution of engine oil, causing engine reliability problems, external hydrocarbon delivery apparatus is able to provide more accurate hydrocarbon delivery rate, since no hydrocarbon is burned before entering the catalyst.

However, hydrocarbon delivery apparatus used in fuel burners and DOC apparatus have clogging or caking issues, which may cause partially blocked nozzles, resulting in temperature control problems. A variety of methods have been used to solve this issue, including purging residue after a hydrocarbon delivery process completes, and using a better design to decrease the chance of caking at the nozzle. Nevertheless, due to lack of effective separation of hydrocarbon from high temperature exhaust gas, these methods are not very reliable.

The temperature control of exhaust gas is also affected by hydrocarbon conversion efficiencies of the heat generating device and the DPF. Ideally hydrocarbon delivered to an exhaust gas processing system should be totally oxidized to avoid hydrocarbon emission caused by the exhaust gas processing system itself. However, limited by the hydrocarbon conversion efficiency of the heat generating device, there is a hydrocarbon breakthrough or hydrocarbon slip. When the DPF is not catalyzed, the hydrocarbon slip level must be lower than regulation limits, while if the DPF is catalyzed, since the DPF can lower down the hydrocarbon level at tailpipe, a higher hydrocarbon slip level is allowed for the heat generating device. The hydrocarbon slip limit and the hydrocarbon conversion efficiencies of the heat generating device and the DPF provide an upper limit to the hydrocarbon delivery rate. When the hydrocarbon conversion efficiency of the heat generating device or the DPF is too low, the hydrocarbon delivery command could be limited to a level not enough to regenerate the DPF. At this situation, a fault needs to be triggered to avoid further damage to the DPF.

The low hydrocarbon conversion efficiency could be either a “real” low efficiency caused by issues in the heat generating device and the DPF, such as a plugged DOC, sulfur poison, or aggregated catalyst particles in the DOC or the DPF, or an “apparent” low efficiency caused by hydrocarbon delivery issues, such as an inaccurate hydrocarbon delivery device. For a system with a “real” low efficiency, a component service, e.g. generating high temperature exhaust gas from the engine or replacing the DOC or DPF, is required to fix the problem. However, if the low efficiency is just “apparent”, as long as system is still capable, e.g., the hydrocarbon delivery apparatus is still able to provide required hydrocarbon delivery rate, the low efficiency can be corrected by compensation.

In addition to low efficiency, overly high hydrocarbon conversion efficiency can also be obtained. As the low hydrocarbon conversion efficiency, the overly high hydrocarbon conversion efficiency could be either an “apparent” high efficiency caused by hydrocarbon delivery issues, or a “real” overly high efficiency, which is mainly caused by an engine fuel system issue, e.g. an issue causing large amount of unburned hydrocarbon to be released into the heat generating device, or hydrocarbon deposit evaporated under high temperature.

To improve temperature control performance in an exhaust gas processing system and at the same time lower down warranty cost, a primary object of the present invention is to provide a hydrocarbon delivery apparatus in which errors in hydrocarbon delivery rate can be detected and hydrocarbon can be separated from exhaust gas after a regeneration process completes.

A further object of the present invention is to provide a temperature controller using the detected error for compensating temperature control.

Another object of the present invention is to provide a diagnosis controller detecting “real” hydrocarbon efficiencies of a heat generating device and a DPF according to the detected error.

Yet another object of the present invention is to provide a temperature controller using the detected “real” hydrocarbon efficiencies to limit hydrocarbon delivery rates.

Yet another object of the present invention is to provide a diagnosis controller that is able to detect engine fuel system issues causing an overly high “real” hydrocarbon efficiency of the heat generating device.

### BRIEF SUMMARY OF THE INVENTION

The present invention provides an apparatus for controlling hydrocarbon delivery in an exhaust gas processing system. More particularly, this apparatus includes a fuel injector and a control manifold, which is fluidly connected to the fuel injector, a fuel control solenoid valve for controlling hydrocarbon supply, a pressure sensor, and a volume changing device. The fuel injector and the solenoid valve are electrically controlled by an ECU (Engine Control Unit), which receives sensing signals from the pressure sensor.

In an embodiment of the present invention, the volume changing device includes a cylinder, which has a piston slidably moving inside it and a spring loaded on the piston for providing a linear relationship between the volume change and the pressure change in the control manifold. The cylinder has a first port fluidly connected to the control manifold and a second port fluidly connected to ambient. In delivery hydrocarbon, the fuel control solenoid valve is energized open, and the piston inside the cylinder moves with the pressure change in the control manifold. The hydrocarbon flow rate can be controlled by controlling the opening time of the fuel injector in a repeating control cycle according to a predetermined delivery rate command and pressure sensing values obtained from the pressure sensor. In a diagnosis cycle, the fuel control solenoid valve is de-energized closed. With hydrocarbon supply being shutoff, the hydrocarbon flow is solely provided by the volume changing device. By comparing the amount of delivered hydrocarbon and the volume change in the control manifold, a Deterioration Factor (DF) can be calculated as a performance indicator of the hydrocarbon delivery apparatus, and a fault is generated when the DF value is too low or too high.

In another embodiment of the present invention, a check valve is positioned through the piston in the cylinder, and the second port of the cylinder is fluidly couple to a compressed air source through a three way air control solenoid valve, which has an outlet port fluidly connected to the second port of the cylinder, a first outlet port fluidly connected to the compressed air source, and a second outlet port fluidly connected to ambient. During normal hydrocarbon delivery, the second outlet port of the air control solenoid is connected to the inlet, and the check valve is closed under the pressure in the control manifold. When a hydrocarbon delivery process completes, with the fuel control solenoid valve being de-energized closed, and the injector being energized open, the inlet of the air control solenoid is connected to the first outlet. When the pressure in the control manifold is released after the hydrocarbon in the control manifold is drained, the compressed air enters the control manifold, purging off the hydrocarbon residue inside it. After the hydrocarbon residue is cleaned, the injector is de-energized closed, and the compressed air the control manifold keeps the hydrocarbon from leaking through the fuel control solenoid valve, thereby separates the hydrocarbon from the exhaust air. The compressed air trapped in the control manifold is released in a prime process when a new hydrocarbon delivery process starts.

The DF value of the hydrocarbon delivery apparatus can be used for compensating hydrocarbon delivery errors in temperature control. In an exemplary temperature control for an exhaust gas processing system including a DOC and a DPF, a command value for a DOC outlet temperature is generated according to a target temperature value for the DPF. Then a required hydrocarbon delivery rate is calculated according to the error between the command value and a measured DOC outlet temperature value. And a PWM duty-cycle command for controlling the injector is generated thereafter with the required hydrocarbon delivery rate. Deteriorations in the hydrocarbon delivery apparatus, especially those caused by nozzle clogging or caking, are reflected in the change of the DF values, which are used in calculating a compensation factor that multiplies the PWM duty-cycle command in compensating the deteriorations. The use of the DF values introduces a compensation loop for the deterioration and the change in the control plant caused by the deteriorations, thereby, can be corrected without affecting temperature control performance.

The DF value can also be used in detecting hydrocarbon conversion efficiencies of the heat generating device and the DPF in an exhaust gas processing system. In the exemplary exhaust gas system, the hydrocarbon conversion efficiency of the DOC is calculated by using the ratio of heat energy gained by the exhaust gas to that released in burning the hydrocarbon delivered by the hydrocarbon delivery apparatus, when an equilibrium or steady status is reached. By including the DF value in the calculation, the “real” hydrocarbon conversion efficiency, which is only determined by the DOC performance, is separated from the “apparent” hydrocarbon conversion efficiency that is also affected by hydrocarbon delivery errors. Similarly, the overall hydrocarbon conversion efficiency of the DOC and the DPF can be calculated and the hydrocarbon conversion efficiency of the DPF can be obtained according to the DOC conversion efficiency and the overall conversion efficiency.

The hydrocarbon conversion efficiencies can be further used in limiting hydrocarbon delivery rate to avoid high hydrocarbon slips, and in detecting failures in the exhaust gas processing system and the engine fuel system. In an exemplary temperature controller, the hydrocarbon conversion efficiency of the DOC together with the maximum allowed hydrocarbon slip value at the DOC outlet are used for limiting the hydrocarbon delivery rate, while the maximum allowed hydrocarbon slip value at the DOC outlet is determined by the hydrocarbon conversion efficiency of the DPF together with a predetermined maximum hydrocarbon slip value at the DPF outlet. In an exemplary diagnosis controller, a component fault, which is indicative of failures in the DOC or the DPF, is triggered when the detected hydrocarbon conversion efficiency is lower than a threshold, and a system fault, which is indicative to failures in the engine system, is triggered if the detected hydrocarbon conversion efficiency is consistently higher than a threshold.

### DESCRIPTION OF THE DRAWINGS

FIG. 1 is a schematic representation of an internal combustion engine with an exhaust gas processing system.

FIG. 2 is a diagrammatic illustration of a fluid delivery apparatus for delivering hydrocarbon into an exhaust gas processing system.

FIG. 3a is a cross-sectional illustration of a volume changing device in a fluid delivery apparatus.

FIG. 3b is a cross-sectional illustration of a volume changing device with a check valve positioned through a piston.

FIG. 4 is a cross-sectional illustration of a volume changing device with a solenoid valve controlling air flow.

FIG. 5 is a flow chart of an interrupt service routine used in calculating a deterioration factor of a hydrocarbon delivery apparatus in an exhaust gas processing system, and diagnosing failures in the hydrocarbon delivery apparatus.

FIG. 6a is a flow chart of an interrupt service routine used in controlling a prime process for a hydrocarbon delivery apparatus.

FIG. 6b is a flow chart of an interrupt service routine used in controlling a purging process for a hydrocarbon delivery apparatus.

FIG. 7a is a block diagram of a temperature controller in an exhaust gas processing system.

FIG. 7b is a block diagram of a compensation block in the temperature controller of FIG. 7a for calculating a compensation factor.

FIG. 7c is a routine used in calculating a compensation factor with a deterioration factor.

FIG. 8 is a flow chart of an interrupt service routine used in calculating a hydrocarbon efficiency of a DOC in an exhaust gas processing system.

FIG. 9a is a block diagram of a part of a temperature controller using an upper limit calculated according to a DOC hydrocarbon conversion efficiency.

FIG. 9b is a block diagram of a part of a temperature controller using an upper limit calculated according to a DOC hydrocarbon conversion efficiency and a DPF hydrocarbon conversion efficiency.

### DETAILED DESCRIPTION OF THE INVENTION

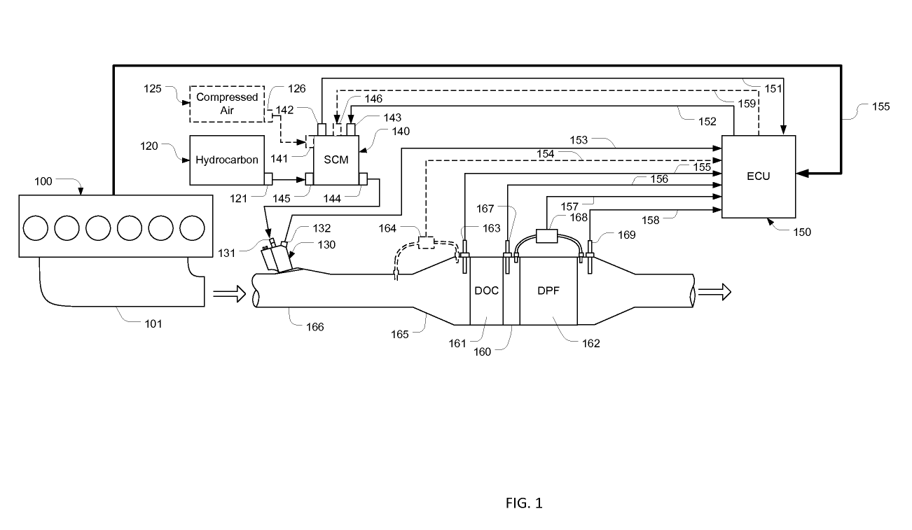

Referring to FIG. 1, exhaust gas generated in an internal combustion engine 100 goes into an exhaust gas passage 166 through an exhaust manifold 101. On the exhaust gas passage 166, a fuel injector 130 is mounted, through which hydrocarbon can be injected into the exhaust gas. Downstream from the exhaust gas passage 166, a DOC 161 is positioned in a catalyst converter 160, on which a temperature sensor 163 is mounted upstream from the DOC 161 and electrically connected to an ECU 150 through lines 155. The catalyst converter 150 is fluidly connected to the exhaust gas passage 166 through a cone reducer 165, and an optional delta P and pressure sensor 164 electrically connected to the ECU 150 through lines 154 can be further used for measuring the pressure difference across the cone reducer 165 and the pressure at the front face of the DOC 161. A DPF 162 is positioned in the catalyst converter 162 downstream from the DOC 161, and two temperature sensors 163 and 169 are mounted upstream and downstream from the DPF 162 respectively. The temperature sensor 163 is electrically connected to the ECU 150 through lines 156, while lines 158 are used to electrically connect the temperature sensor 169 to the ECU 150. The pressure drop across the DPF 162 and the pressure at the outlet of the DPF are measured by a deltaP and pressure sensor 168, which is electrically connected to the ECU 150 through lines 157.

During normal operations, reducing species, such as CO and unburned hydrocarbon emitted from the engine 100 are oxidized in the DOC and the DPF if it is also coated with oxidation catalyst, and in a DPF regeneration event, in which the soot collected in the DPF is removed by burning in high temperature exhaust air, the DOC is used for oxidizing the hydrocarbon released through the fuel injector 130 in generating exotherm. In a system of FIG. 1, hydrocarbon is provided to the injector 130 from a hydrocarbon source 120 through a supply control module 140. During a DPF regeneration, hydrocarbon is pressed into a port 145 of the supply control module 140 from a port 121 of the hydrocarbon source 120, and further flows from a port 144 of the supply control module 140 to a port 131 of the injector 130. In the supply control module 140, the pressure of the hydrocarbon is reported to the ECU 150 through a port 142 and lines 151, and the hydrocarbon flow to the injector 130 is controlled by the ECU 150 though lines 152 connected to a port 143. After the DPF regeneration, to prevent hydrocarbon coking on the injector surface, hydrocarbon residue can be purged by using a compressed air, which is provided by a compressed air source 125 through a port 142 and a port 141 of the supply control module 140. The compressed air can be controlled by the ECU 150 though lines 159 connected to a port 146.

During a DPF regeneration, exhaust air temperature needs to be controlled at a certain level. Too high temperature may damage the DPF, while too low temperature is not enough for burning soot in the DPF, causing regeneration failures. To control exhaust air temperature, the delivery rate of the hydrocarbon through the injector 130 needs to be controlled. The hydrocarbon delivery control can be achieved by controlling the opening time of the injector 130 in a repeating control cycle. In the system of FIG. 1, the opening time of the injector 130 is controlled by the ECU 150 through lines 153 connected to a port 132 of the injector 130, according to the sensing information obtained from the sensors 164, 163, 167, 168, 169, the hydrocarbon pressure sensor in the supply control module 144, and the sensing information obtained from the engine 100 through lines 155, which may include exhaust gas mass-flow rate, engine fueling rate, engine speed, vehicle speed, and engine operating status.

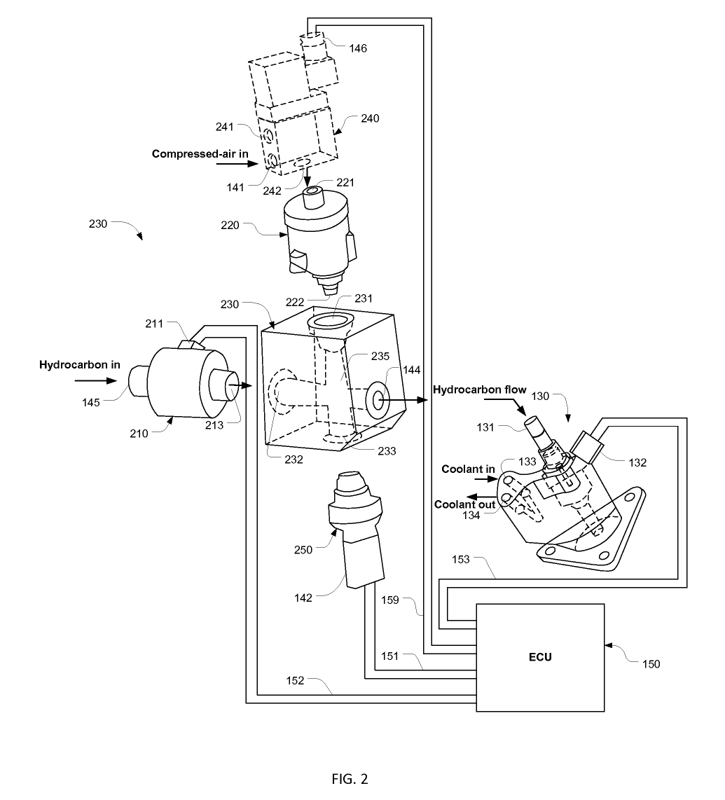

In the system of FIG. 1, the function of the supply control module 140 is to control hydrocarbon flow to the injector 130. As shown in FIG. 2, the supply control module 140 can be realized with a control manifold 230 fluidly connected with a fuel control solenoid valve 210, a buffer device 220, and a pressure sensor 250. Inside the control manifold 230, a chamber 235 is fluidly connected to four ports 232, 233, 231, and 144. The port 232 is connected to a port 213 of the fuel control solenoid 210, which is controlled by the ECU 150 through the lines 152 connected to a port 211. When the fuel solenoid valve 210 is energized, hydrocarbon flows into the chamber 235 through the port 145, the fuel solenoid valve 210, the port 213 and the port 232 under the pressure provided by the hydrocarbon source 120. Hydrocarbon pressure in the chamber 235 is measured by the pressure sensor 250 fluidly connected to the port 233, and the port 131 of the injector 130 is fluidly connected to the port 144. When the injector 130 is energized open, the hydrocarbon flow rate through the injector 130 is determined by the pressure in the chamber 235, thereby by adjusting the energizing time of the injector 130 in a repeating cycle according to the pressure value obtained from the sensor 250, the hydrocarbon flow rate can be controlled. To prevent the injector 130 from being over-heated, coolant is cycled in the injector from a port 133 to a port 134.

A port 231 of the control manifold 230 is fluidly connected to a port 222 of the buffer device 220, a function of which is damping pressure in the control manifold. When a DPF regeneration process completes, both of the solenoid valve 210 and the injector 130 are de-energized. If hydrocarbon is still trapped in the control manifold 235, then the hydrocarbon adjacent to the nozzle tip of the injector 130 may have a high temperature, since the nozzle tip has to be positioned in the exhaust air. The high temperature may coke the hydrocarbon, blocking hydrocarbon flow and deteriorating hydrocarbon delivery performance. To decrease the chance of coking, a compressed air can be introduced in the hydrocarbon delivery apparatus after a hydrocarbon delivery process completes to purge the trapped hydrocarbon. In FIG. 2, an optional purging means includes the air solenoid valve 240 with a port 242 fluidly connected to a port 221 of the buffer device 220. The port 141 of the solenoid valve 240 is fluidly connected to the compressed air source 125, and another port 241 is exposed to ambient or fluidly connected to a hydrocarbon tank (not shown). The solenoid valve 240 is controlled by the ECU 150 through lines 159 electrically connected to a port 146.

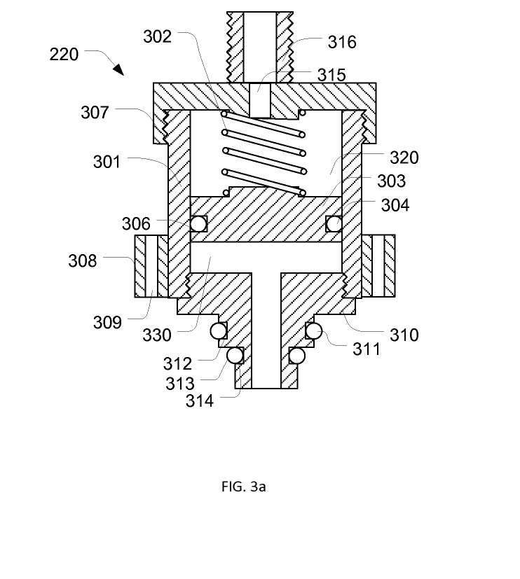

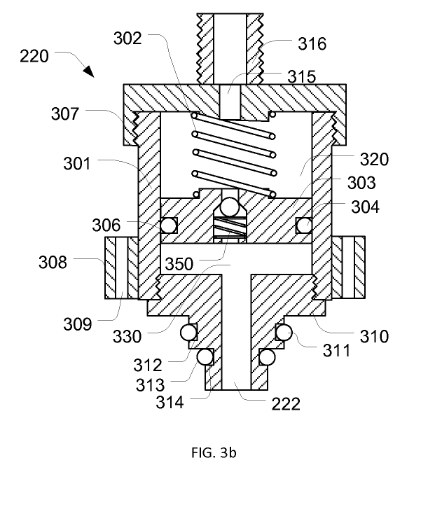

In the hydrocarbon delivery apparatus of FIG. 2, an embodiment of the buffer device 220 is shown in FIG. 3a. This device includes a cylinder body 301 with a cap 307 screwed on its top end and a connector assembly 310 screwed on its lower end. In the cylinder body 301, a piston 303 separates its internal space into two chambers: 320 and 330. The chamber 320 is further sealed from the chamber 330 by an o-ring 304 seated in a groove 306. Inside the chamber 320, a spring 302 is positioned in between the cap 307 and the piston 303, and a venting port 315 in the cap 307 fluidly connects the chamber 320 to ambient. On the top of the cap 307, a male treaded adaptor 316 can be used for further fluidly connecting the chamber 320 back to a hydrocarbon tank, so that in case of sealing failure, the hydrocarbon leaking through the seal 304 can be drained back to the hydrocarbon tank. The chamber 330 is fluidly connected to the chamber 235 in the control manifold 230 through the connector assembly, which has two o-rings 311 and 313 seated in the grooves 312 and 314 respectively. On the cylinder 301, two mounting flanges 308 with holes 309 are used to fix the buffer device 220 on the control manifold 230.

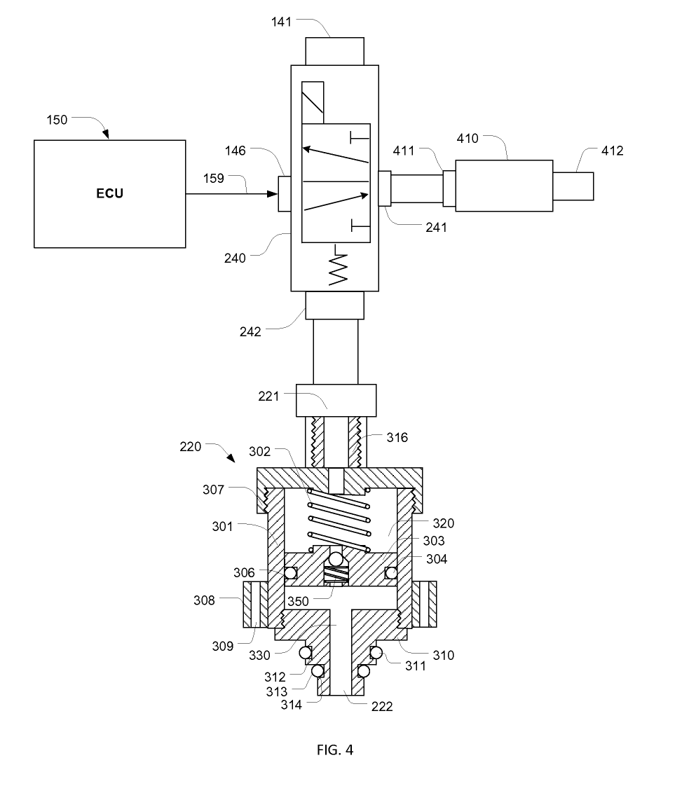

In the hydrocarbon delivery apparatus of FIG. 2, if the optional purging means is used, as shown in FIG. 3b, a check valve 350 is positioned in the piston 303 for passing compressed air into the chamber 330. In the optional purging means, the solenoid valve 240 can be a three-way solenoid valve depicted in FIG. 4. When the three-way solenoid valve 240 is energized, the chamber 320 in the buffer device 220 is fluidly connected to the compressed air source, while being de-energized, the three-way solenoid valve 240 fluidly connects the chamber 320 to ambient. To decrease the air releasing noise when the three-way solenoid 240 is de-energized, the optional purging means can further include a muffler 410 with a port 411 in communication to the port 241 of the three-way solenoid valve 240 and another port 412 exposed to ambient or fluidly connected to the hydrocarbon tank.

In the hydrocarbon delivery apparatus of FIG. 2, if the optional purging means is not available and the buffer device of FIG. 3a is used, then when the fuel shut-off solenoid valve 210 is energized, under the pressure of the hydrocarbon source 120 (FIG. 1), hydrocarbon flows into the chamber 235, building pressure therein. The pressure in the chamber 235 moves the piston 303 upward and the volume of the chamber 330 expands. When a pressure P is applied, if the cross area of the piston surface is A, and the spring constant of the spring 302 is K, then with friction effects and the mass of the spring and the piston neglected, the volume change of the chamber 330, ΔV, is proportional to a change ΔP in the pressure P:

ΔP=K*ΔV/A² (1).

When the fuel shut-off valve 210 is de-energized, then the volume change of the chamber 330 is only caused by release of hydrocarbon when the injector 130 is energized, i.e.,

ΔV=∫(D/p)dt (2),

wherein D is the hydrocarbon delivery rate (hydrocarbon mass flow rate passing through the injector 130).

According to equations (1) and (2), the relation between the hydrocarbon delivery rate D and the pressure in the chamber 235 then follows the equation below:

$$D = \frac{d P}{d t} \frac{ρ {A}^{2}}{K} , \qquad ( 3 )$$

where ρ is the density of the hydrocarbon being delivered.

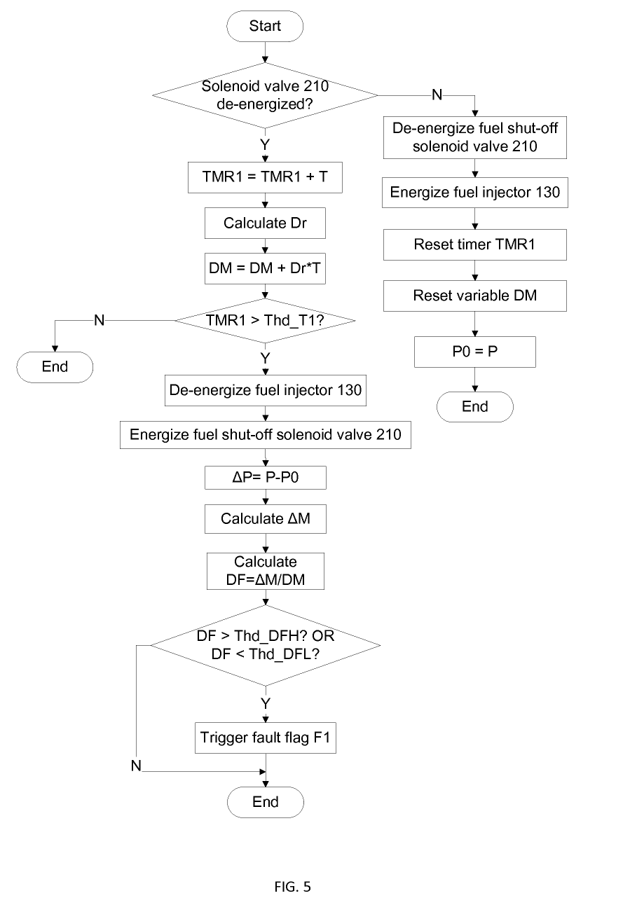

The relation of equation (3) provided by the buffer device can be used for detecting deteriorations in the hydrocarbon delivery apparatus. An exemplary detection algorithm can be realized with a timer-based interrupt service routine that runs periodically in the ECU 150 with a repeating period of T, as shown in FIG. 5. In this routine, the value of a timer TMR1 is the detection time starting from the moment when the solenoid valve 210 is de-energized and the fuel injector 130 is energized to the current moment when the routine is executed. The value of a variable DM is the amount of hydrocarbon being delivered during the detection time calculated using an expected hydrocarbon delivery rate Dr, while another variable ΔM has the value of a hydrocarbon mass change in the chamber 330. According to equation (3), ΔM can be calculated using the following equation:

$$Δ M = Δ P \frac{ρ {A}^{2}}{K} , \qquad ( 4 )$$

where ΔP is the pressure change during the detection time, while Dr can be calculated using the following equation:

Dr=CᵢAᵢ\sqrt{2ρP} (5),

where Cᵢ is the orifice flow coefficient of the injector, and Aᵢ is the minimum cross-section area of the injector nozzle. When the solenoid valve 210 is de-energized, since the hydrocarbon is solely provided by the buffer chamber 220, the hydrocarbon amount DM equals to the hydrocarbon mass change in the chamber 330, ΔM, and therefore, the difference between the calculated ΔM value and DM value is an indication of issues in the hydrocarbon delivery apparatus. According to equations (4) and (5), the issues that cause the mismatch of the ΔM value and the DM value include injector nozzle problems, e.g., partially blocked injector nozzle caused by coked hydrocarbon, buffer device failures, e.g., the piston is stuck in the buffer, and impure or wrong hydrocarbon, e.g. hydrocarbon mixed with air or water.

Referring back to the service routine of FIG. 5, once the routine is enabled, the status of the solenoid valve 210 is examined. If it is energized, then this is the first cycle of the detection. The solenoid valve 210 is de-energized, and the fuel injector 130 is energized. The timer TMR1 and variable DM are reset to 0 thereafter, and the routine ends after the current pressure value obtained from the pressure sensor 250 (FIG. 2), P, is assigned to a variable P0. Referring back to the examination of the status of the solenoid valve 210, if it is de-energized, then the TMR1 value is increased by T, and the expected hydrocarbon delivery rate Dr is calculated according to equation (5). The DM value is calculated thereafter, and the TMR1 value is compared with a threshold Thd_T1, if it is not higher than Thd_T1, then the routine ends, otherwise, the fuel injector 130 is de-energized, and the shut-off solenoid valve 210 is energized. The difference between the current pressure and the P0 value, ΔP, is then calculated and based on the ΔP value, the ΔM value is calculated according to equation (4). With the ΔM value and the DM value, a deterioration factor value, DF, is calculated and compared with two thresholds Thd_DFL and Thd_DFH. If it is higher than Thd_DFH or lower than Thd_DFL, then a fault flag F1 is triggered, otherwise, the routine ends. The fault flag F1 is an indication of the failures in the hydrocarbon delivery apparatus, and the interrupt service routine can be enabled in a normal hydrocarbon delivery process or in a special diagnostic event at the end of a hydrocarbon delivery process.

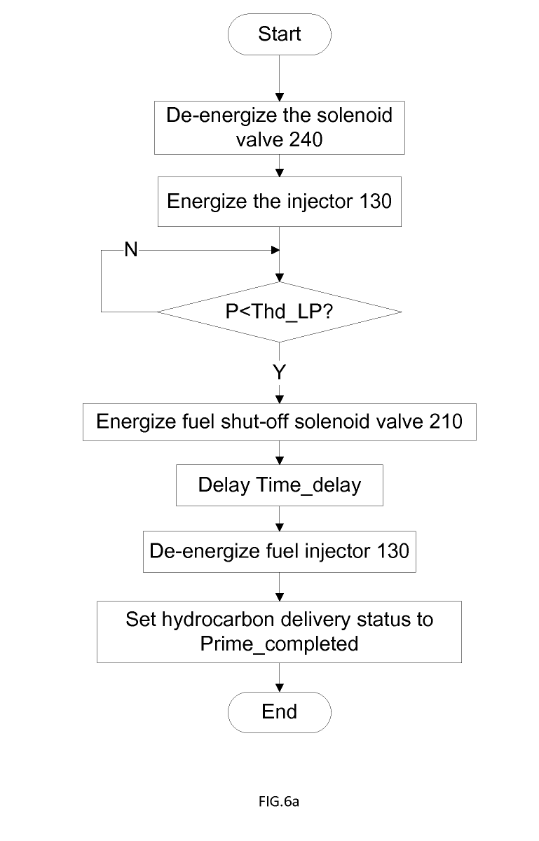

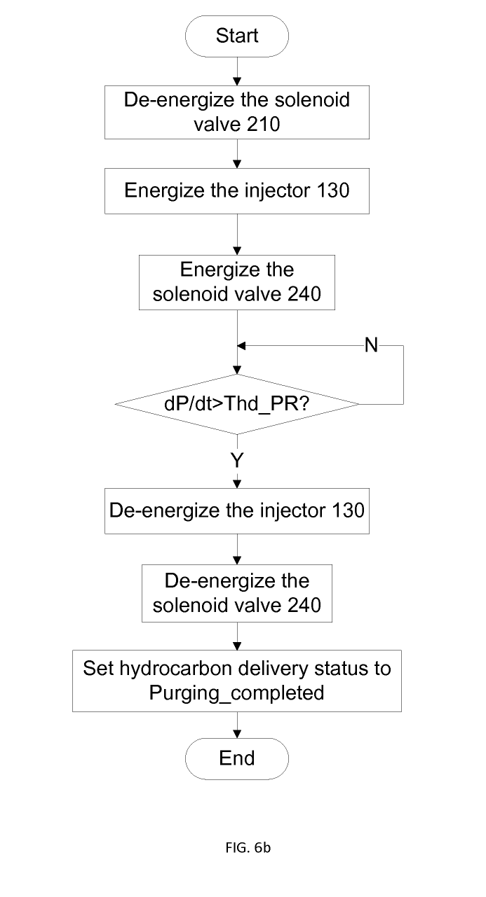

Referring back to FIG. 2, to prevent coking caused by the hydrocarbon residue in the chamber 235 and the injector 130, a purging means can be used to empty the hydrocarbon residue out. When a purging means of FIG. 4 is used, the priming and purging of the hydrocarbon delivery apparatus of FIG. 2 can be controlled by control routines running in the ECU 150. An exemplary routine for controlling priming is shown in FIG. 6a. When the routine starts, the solenoid valve 240 is de-energized closed and then the injector 130 is energized open to release trapped air. Once the trapped air is released, i.e., when the measured pressure is lower than a threshold Thd_LP, the shut-off solenoid valve 210 is energized. After a delay time of Time_delay, which allows hydrocarbon to be filled in the hydrocarbon delivery apparatus, the fuel injector is 130 is de-energized closed, and after the hydrocarbon delivery status is set to Prime_completed, the routine ends. Referring to FIG. 6b, in a routine controlling purging, the solenoid valve 210 is de-energized closed to shut-off hydrocarbon supply, and then both of the injector 130 and the solenoid valve 240 are energized open to press out hydrocarbon residue in the hydrocarbon delivery apparatus. When the hydrocarbon delivery apparatus is empty, compressed air is released through the injector 130, and due to the difference in density of hydrocarbon and compressed air, a sudden drop of pressure will be detected. This pressure drop can be used as an indication of the purging completion. In the routine of FIG. 6b, if a pressure drop dP/dt is higher than a threshold Thd_PR, then the injector and the solenoid valve 240 are de-energized, and the routine ends after the hydrocarbon delivery status is set to Purging_completed. After the purging process completes, compressed air is trapped in the hydrocarbon delivery apparatus. When the trapped air pressure is higher than that of hydrocarbon supply, it will keep hydrocarbon from leaking through the shut-off valve 210. Thereby, the possibility of coking is further lowered down. The compressed air trapped in the control manifold may leak causing pressure loss. To keep the air pressure in the control manifold higher than that of the hydrocarbon supply, a pressure control can be used to refill compressed air by momentarily energizing the solenoid valve 240 when the pressure sensing value obtained from the pressure 250 is low. The pressure control is disabled during a regeneration process.

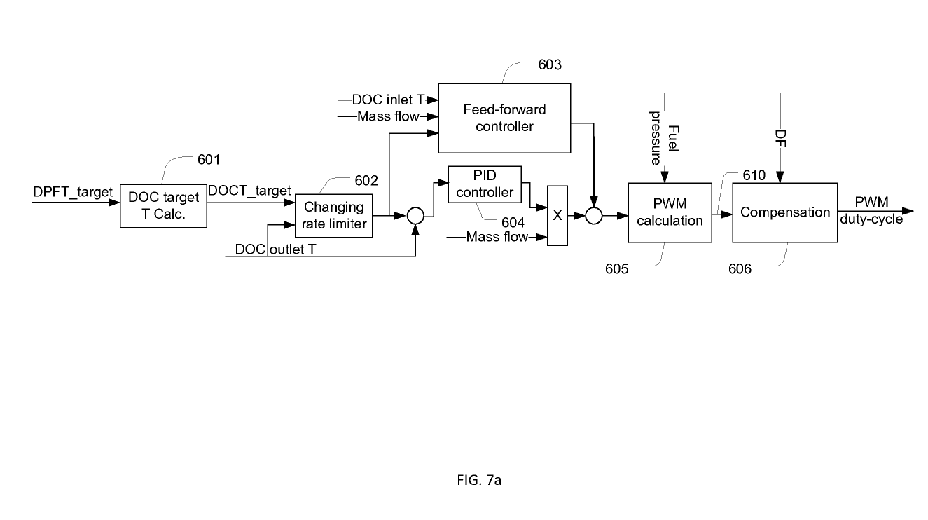

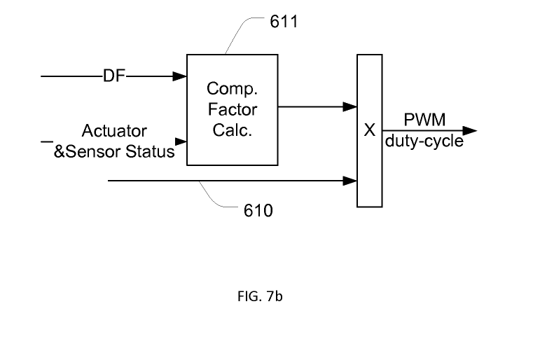

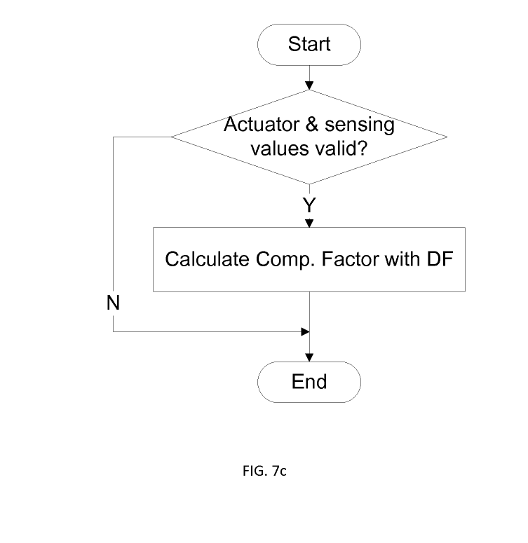

With the deterioration factor value DF detected, a compensation for hydrocarbon delivery accuracy can be implemented in temperature control during DPF regeneration. Referring to FIG. 7a, the temperature control of a DPF system includes a block 601 for calculating a DOC target temperature (DOCT_target) with a DPF target temperature value (DPFT_target). The DOC target temperature is then used with a DOC outlet temperature sensing value (DOC outlet T) obtained from the sensor 167 (FIG. 1) in a block 602 for generating a DOC temperature command value. The function of the block 602 is to provide a temperature profile for limiting temperature changing rate, so that temperature gradient and thermal stress in the DOC and DPF can be controlled low. And the DOC temperature command value generated in the block 602 is compared with the DOC outlet temperature sensing value and the result error value is used by a PID controller block 604 for calculating a PID control command. In the temperature control, the DOC temperature command value is also used by a feed-forward controller 603 together with a DOC inlet temperature value (DOC inlet T) obtained from the sensor 163 and a mass flow value (Mass flow) indicative of the mass flow rate of the exhaust gas in calculating a feed-forward control value. After a non-linear compensation, which is achieved by multiplying the PID control value with the mass flow value, the product of the multiplication is added to the feed-forward control value, and the result value is used by a PWM calculation block in generating a PWM command 610 together with a hydrocarbon pressure value (Fuel pressure) indicative of the pressure of hydrocarbon supply. The PWM command 610 is then compensated by using the DF value in a hydrocarbon delivery compensation block 606 and a PWM duty-cycle value is generated for controlling the injector 130 in controlling hydrocarbon flow rate.

A variety of methods can be used in compensating the PWM command using the DF value. An exemplary method is shown in FIG. 7b. In this method, a compensation factor value is calculated in a block 611 with the DF value together with a status vector value, which indicates the validity of the actuator, i.e., the hydrocarbon delivery apparatus, and sensor sensing values, including that obtained from the DOC inlet temperature sensor 163, the DOC outlet sensor 167, the DPF outlet temperature sensor 169, and the mass flow sensing value. The block 611 can be realized with a simple routine depicted in FIG. 7c. In this routine, the compensation factor is only calculated when the status vector value shows the actuator and the sensing values are valid, i.e., no error is reported for the actuator and the sensors. If the status vector value shows invalidity, then the compensation factor is not calculated and thereby its previous value is used. The compensation factor value calculated in the block 611 multiplies the PWM command 610 in generating the PWM duty-cycle. And a simple method for calculating the compensation factor value is using a lookup table with the DF value as an input.

In addition to being applied in temperature control, the DF value can also be used in calculating the hydrocarbon conversion efficiency of a DOC. Referring back to FIG. 1, the exotherm generated in the DOC 161 is mainly provided by hydrocarbon oxidation. Accordingly the difference between the temperature sensing values obtained from the sensor 163 and the sensor 167 is a function of the hydrocarbon amount in the exhaust flow:

(T₁₆₇−T₁₆₃)*Cₚ*M_{fe}+m_{DOC}*Cₘ*T_{DOC}+Pₑ=D*DF*η_{d}*LHV (6),

where T₁₆₇ and T₁₆₃ are, respectively, the temperature sensing values obtained from the sensor 163 and the sensor 167, Cₚ the heat capacity at constant pressure of the exhaust gas, M_{fe} the exhaust mass flow rate, m_{Doc} the mass of the DOC device including the DOC 161 and its package, Cₘ the heat capacity of the DOC device, T_{DOC} the average temperature of the DOC device, Pₑ the power of the heat exchange between the DOC device and ambient, η_{d} the hydrocarbon conversion efficiency, and LHV is the low heating value of the hydrocarbon. In equation (6), if the heat exchange between the DOC device and the ambient is negligible, at steady status, i.e., when the temperature T_{DOC} keeps constant, then the equation (6) can be simplified as:

(T₁₆₇−T₁₆₃)*Cₚ*M_{fe}=D*DF*η_{d}*LHV (7),

and the hydrocarbon conversion efficiency η_{d} thereby can be calculated using the following equation:

η_{d}=(D*DF*LHV)/[(T₁₆₇−T₁₆₃)*Cₚ*M_{fe}] (8).

And an average hydrocarbon conversion efficiency, \tilde{η}\tilde{η_{d}}, can be calculated accordingly:

[symbol]

=∫(D*DF*LHV)dt/∫[(T₁₆₇−T₁₆₃)*Cₚ*M_{fe}]dt (9).

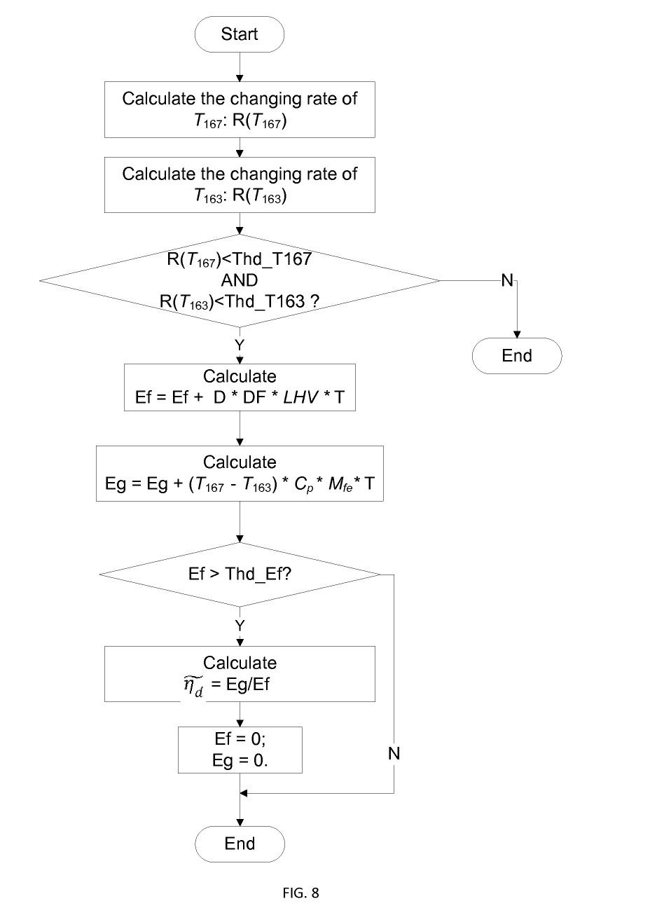

Based on equation (9), a service routine running periodically for a timer based interrupt can be used for calculating the average hydrocarbon conversion efficiency of DOC. Referring to FIG. 8, after the routine starts, the changing rates of the temperatures T₁₆₇ and T₁₆₃ are calculated. If both of the changing rates are low, i.e, the changing rate of the temperature T₁₆₇ is lower than a threshold Thd_T167, while that of the temperature T₁₆₃ is lower than a threshold Thd_T163, then a hydrocarbon energy Ef and a gas enthalpy change Eg is calculated, otherwise, the routine ends. The calculated Ef value is then compared with a threshold Thd_Ef, if it is not higher than Thd_Ef, then the routine ends, otherwise, the average hydrocarbon conversion efficiency \tilde{η}\tilde{η_{d}} is calculated by dividing Eg with Ef. The Ef and Eg value are cleared to 0 thereafter, and the routine ends.

The hydrocarbon conversion efficiency, including both of the efficiency η_{d} and [symbol] , is an indication of the DOC performance. Low hydrocarbon conversion efficiency of the DOC may create a few issues, including high level of hydrocarbon slips, which cause emission issues, and low regeneration temperature of the DPF, which leads to a mal-distribution of soot inside the DPF, causing reliability problems. To avoid regenerating with a problematic DOC, once low hydrocarbon conversion efficiency is detected, a fault needs to be reported.

When a low hydrocarbon efficiency fault is triggered, the DPF regeneration needs to be disabled. However, to fix the problem, it is not always necessary to replace the DOC. Low hydrocarbon conversion efficiency could be caused by a few factors including partially plugged DOC front face, sulfur poison, and damaged catalyst. Normally, partially plugged DOC front face and sulfur poison are recoverable, i.e., at high temperature, the soot plugging the DOC front face and the sulfur compounds deteriorating DOC performance can be removed, while a damaged catalyst, for example, a catalyst in which platinum particles aggregates at high temperature, is not recoverable. These factors can be separated by using a high temperature exhaust flow, which could be generated by running the engine at a high torque mode and/or using post injectors to burn extra fuel in the engine. After passing through a high temperature exhaust flow for a certain period of time, if the conversion efficiency is recovered, then the low hydrocarbon conversion efficiency is caused by recoverable factors, otherwise, a DOC replacement is needed.

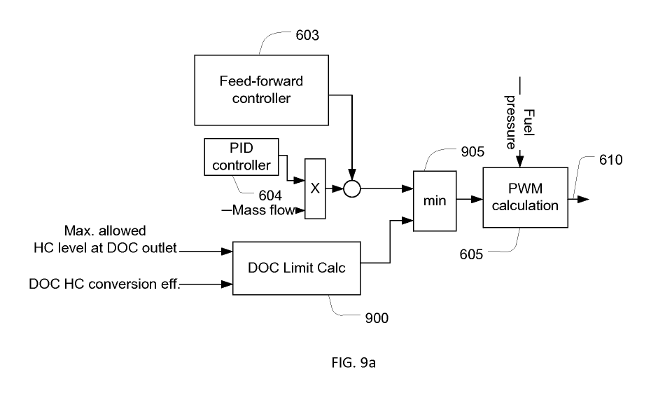

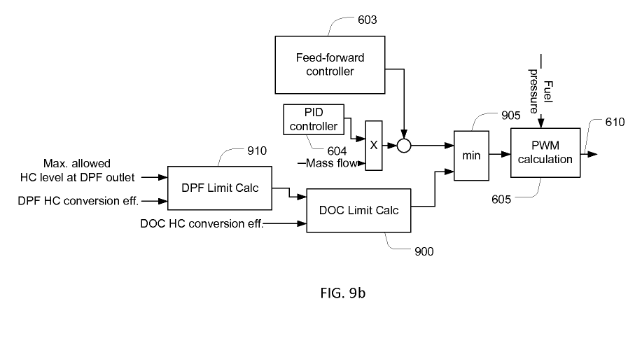

In addition to triggering faults, the hydrocarbon conversion efficiency value can also be used for limiting hydrocarbon delivery rate to avoid generating too much hydrocarbon slips or causing too high temperature gradient in a catalyst coated DPF. The hydrocarbon delivery rate limit can be positioned before a PWM control signal is generated. Referring to FIG. 9a, in an exemplary DOC control system of FIG. 6, a “min” calculation block 905, in which the minimum value of its inputs are calculated, is positioned right before the PWM calculation block 610. The “min” calculation block 905 has two inputs, one is the hydrocarbon delivery command generated with a feed-forward controller 603 and a PID controller 604, and the other one is a hydrocarbon delivery limit value calculated in a DOC limit calculation block 900 with two inputs of the maximum allowed hydrocarbon level at DOC outlet and a DOC hydrocarbon conversion efficiency. The maximum allowed hydrocarbon level at DOC outlet can be further determined by the maximum allowed hydrocarbon level at DPF outlet together with the DPF working status, and with the calculated DOC hydrocarbon conversion efficiency [symbol] , the limit value for the hydrocarbon delivery can then be calculated according to the following equation:

Dₘₐₓ=C_{HCD}/(1− [symbol] ) (10),

where Dₘₐₓ is the limit value for the hydrocarbon delivery, and C_{HCD} is the maximum allowed hydrocarbon level at DOC outlet.

The calculated hydrocarbon conversion efficiency values can be higher than 100%. The overly high hydrocarbon conversion efficiency is an indication of high hydrocarbon level in engine-out exhaust air, which may further suggests a fuel injector issue of the engine, such as a fuel injector stuck-open issue, or a hydrocarbon deposit issue, which is caused by impingement of hydrocarbon droplets on the inner wall of the exhaust pipe at low temperature and evaporates when exhaust air temperature rises up. The overly high hydrocarbon conversion efficiency caused by deposited hydrocarbon only happens during a transient when exhaust air temperature changes from low to high. If the overly high hydrocarbon conversion efficiency exists in a long period of time, then a fault needs to be triggered for the engine fuel system. The long time overly high efficiency can be detected using the interrupt service routine of FIG. 8. In the routine, the threshold Thd_Ef is the minimum hydrocarbon energy needed for calculating the average hydrocarbon conversion efficiency value. If Thd_Ef is set higher than that of deposited hydrocarbon, then when the DPF is not in regeneration, an overly high efficiency can only be detected when there is an extra hydrocarbon source.

Referring back to FIG. 1, if the heat exchange between exhaust air and ambient in the connection pipe 160 is negligible, then according to equation (8), if the temperature sensing value T₁₆₉ acquired from the sensor 169 is used instead of the T₁₆₇ value, then the overall hydrocarbon conversion efficiency of the DOC and DPF, ηₐ, can be obtained with the following equation, assuming the heat released by burning soot is negligible compared to that released by oxidizing hydrocarbon:

ηₐ=(D*DF*LHV)/[(T₁₆₉−T₁₆₃)*Cₚ*M_{fe}] (11).

The overall hydrocarbon conversion efficiency ηₐ together the DOC hydrocarbon conversion efficiency η_{d} can be further used to calculate the DPF hydrocarbon conversion efficiency η_{f} according to the following equation:

η_{f}=(ηₐ−η_{d})/(1−η_{d}) (12).

An interrupt service routine similar to the one of FIG. 8 can be used for calculating an average overall hydrocarbon conversion efficiency, and together with an average DOC hydrocarbon conversion efficiency, an average DPF hydrocarbon conversion efficiency can be calculated according to equation (12). Similar to the DOC hydrocarbon conversion efficiency, the DPF hydrocarbon conversion efficiency is an indication of the DPF performance. A fault needs to be triggered when a low DPF hydrocarbon conversion efficiency is detected.

The DPF hydrocarbon conversion efficiency can also be used for determining the maximum allowed hydrocarbon level at DOC outlet in limiting Hydrocarbon delivery rate. Referring to FIG. 9b, in an exemplary control system, the input of the maximum allowed hydrocarbon level at DOC outlet to the block 900 is provide by a DPF limit calculation block 910. Similar to the block 900, the block 910 has two inputs of the maximum allowed hydrocarbon level at DPF outlet and the DPF hydrocarbon conversion efficiency, and the maximum allowed hydrocarbon level at DOC outlet, C_{HCF}, can be calculated using the following equation:

C_{HCF}=C_{HCD}/(1− [symbol] ) (10),

where [symbol] is an average DPF conversion efficiency.

While the present invention has been depicted and described with reference to only a limited number of particular preferred embodiments, as will be understood by those of skill in the art, changes, modifications, and equivalents in form and function may be made to the invention without departing from the essential characteristics thereof. Accordingly, the invention is intended to be only limited by the spirit and scope as defined in the appended claims, giving full cognizance to equivalents in all respects.

What is claimed is:

1. A fluid delivery apparatus for delivering a first fluid into a second fluid, comprising:
a flow-control solenoid valve with an inlet port and an outlet port for controlling a flow of said first fluid;
a pressure sensing means generating a pressure sensing signal indicative of a pressure of said first fluid at said outlet port of said flow-control solenoid valve;
an injector for delivering said first fluid into said second fluid having its inlet port fluidly coupled to said outlet port of said flow-control solenoid valve;
a volume changing device with an outlet port fluidly coupled to said outlet port of said flow-control solenoid valve having a volume change when a pressure of said first fluid varies at said outlet port of said flow-control solenoid valve;
a fluid delivery controller configured to operate said flow-control solenoid valve and said injector for delivering said first fluid into said second fluid;
and
a diagnostic controller configured to generate a diagnosis signal indicative of an anomaly of said fluid delivery device according to at least a value of said pressure sensing signal obtained from said pressure sensing means after operating said flow-control solenoid closed and operating said injector open.

2. The fluid delivery apparatus of claim 1, wherein said diagnostic controller is further configured to calculate a pressure change at said outlet port of said flow control solenoid valve in response to at least two said values of said pressure sensing signal.

3. The fluid delivery apparatus of claim 1, wherein said volume changing device further includes a cylinder having a first port fluidly coupled to said outlet port of said flow-control solenoid valve.

4. The fluid delivery apparatus of claim 3, wherein said volume changing device further includes a piston slidably positioned in said cylinder, and a spring loaded on said piston.

5. The fluid delivery apparatus of claim 3, wherein said cylinder in said volume changing device includes a second port fluidly coupled to an inlet of an air-control solenoid valve, which further has a first outlet fluidly coupled to a compressed-air source and a second outlet in fluid communication with ambient.

6. The fluid delivery apparatus of claim 5, further comprising a check valve mounted through said piston, and said check valve has an inlet port fluidly connected to said second port of said volume changing device and an outlet port fluidly connected to said first port of said volume changing device.

7. The fluid delivery apparatus of claim 6, wherein said fluid delivery controller is further configured to operate said injector open and operate said air-control solenoid valve to fluidly connect its inlet to its first outlet after operating said flow-control solenoid valve closed to purge out a residue of said first fluid contacting said injector after a fluid delivery process completes, and operate said injector closed and operate said air-control valve to fluidly connect its inlet to its second outlet when a changing rate of said pressure sensing signal obtained from said pressure sensing means is higher than a pre-determined threshold.

8. The fluid delivery apparatus of claim 6, wherein said fluid delivery controller is further configured to release trapped air by operating said air-control solenoid to fluidly connect its inlet to its first outlet and operating said injector open before a fluid delivery process starts.

9. An exhaust gas processing system of an engine comprising:
a diesel particulate filter for trapping particulate matter emitted from said engine;
a heat generating device positioned upstream from said diesel particulate filter for increasing exhaust gas temperature during a regeneration process of said diesel particulate filter;
a hydrocarbon delivery apparatus for controlling a hydrocarbon delivery rate to said heat generating device according to a control command, including a flow-control solenoid valve with an inlet port and an outlet port for controlling a flow of hydrocarbon, a pressure sensing means generating a pressure sensing signal indicative of a pressure of hydrocarbon at said outlet port of said flow-control solenoid valve, an injector for delivering hydrocarbon into exhaust gas having its inlet port fluidly coupled to said outlet port of said flow-control solenoid valve, a volume changing device with an outlet port fluidly coupled to said outlet port of said flow-control solenoid valve having a volume change when a pressure of hydrocarbon varies at said outlet port of said flow-control solenoid valve, a fluid delivery controller configured to operate said flow-control solenoid valve and said injector for controlling said hydrocarbon delivery rate according to said control command, and a component diagnostic controller configured to generate a component diagnosis signal indicative of an anomaly of said fluid delivery device according at least a value of said pressure sensing signal obtained from said pressure sensing means after operating said flow-control solenoid closed and operating said injector open;
a first temperature sensor positioned downstream from said hydrocarbon delivery apparatus; and
a temperature controller configured to generate said control command for said hydrocarbon delivery apparatus in controlling a temperature of said diesel particulate filter according to at least a sensing value obtained from said temperature sensor.

10. The exhaust gas processing system of claim 9, wherein said temperature controller is further configured to multiply a flow rate value, which is indicative of a mass flow rate of exhaust gas, with a control value generated according to a predetermined target value and a sensing value obtained from said first temperature sensor, in generate said control command.

11. The exhaust gas processing system of claim 9, wherein said temperature controller is further configured to receive said component diagnosis signal generated by said diagnostic controller of said hydrocarbon delivery apparatus and generate said control command according to at least said component diagnosis signal.

12. The exhaust gas processing system of claim 11, wherein said temperature controller is further configured to generate a compensation factor value according to at least a value of said component diagnosis signal, and multiply said compensation factor value with a control value generated according to a predetermined target value and a sensing value obtained from said first temperature sensor, in generating said control command.

13. The exhaust gas processing system of claim 9, further comprising:
a second temperature sensor positioned downstream from said diesel particulate filter, wherein said temperature controller is further configured to generated said control command according to at least sensing values obtained from said first temperature sensor, and said second temperature sensor.

14. The exhaust gas processing system of claim 9, further comprising:
a system diagnosis controller configured to receive said component diagnosis signal created by said component diagnosis controller of said hydrocarbon delivery apparatus and generate a system diagnosis signal indicative of a hydrocarbon conversion efficiency in said exhaust gas processing system according to at least said component diagnosis signal.

15. The exhaust gas processing system of claim 14, wherein said system diagnosis controller is further configured to generate said system diagnosis signal according to a sensing value obtained from said first temperature sensor, a flow rate value indicative of a mass flow rate of exhaust gas, and a hydrocarbon delivery rate value indicative to a hydrocarbon delivery rate to said heat generating device.

16. The exhaust gas processing system of claim 15, wherein said temperature controller is further configured to generate an upper limit value for said control command in response to at least said system diagnosis signal.

17. The exhaust gas processing system of claim 9, further comprising:
a second temperature sensor positioned downstream from said diesel particulate filter, wherein said system diagnosis controller is configured to receive said component diagnosis signal created by said component diagnosis controller of said hydrocarbon delivery apparatus and generate a first system diagnosis signal indicative of a hydrocarbon efficiency in said heat generating device and a second system diagnosis signal indicative of a hydrocarbon conversion efficiency in said diesel particulate filter according to at least said component diagnosis signal, and sensing values obtained from said first temperature sensor and said second temperature sensor.

18. The exhaust gas processing system of claim 17, wherein said temperature controller is further configured to generate an upper limit value for said control command in response to at least said first system diagnosis signal and said second system diagnosis signal.

19. An exhaust gas processing system of an engine comprising:
a diesel particulate filter for trapping particulate matter emitted from said engine;
a heat generating device positioned upstream from said diesel particulate filter for increasing exhaust gas temperature during a regeneration process of said diesel particulate filter;
a hydrocarbon delivery apparatus for controlling a hydrocarbon delivery rate to said heat generating device according to a control command;
a first temperature sensor positioned downstream from said hydrocarbon delivery apparatus;
a system diagnosis controller configured to generate a first system diagnosis signal indicative of a hydrocarbon conversion efficiency in said exhaust gas processing system; and
a temperature controller configured to generate said control command for said hydrocarbon delivery apparatus in controlling a temperature of said diesel particulate filter according to at least a sensing value obtained from said first temperature sensor, and to generate an upper limit for said control command according to at least said first system diagnosis signal.

20. The exhaust gas processing system of claim 19, further comprising:
a second temperature sensor positioned downstream from said diesel particulate filter, wherein said system diagnosis controller is configured to generate a second system diagnosis signal indicative of a hydrocarbon conversion efficiency in said diesel particulate filter according to at least sensing values obtained from said first temperature sensor and said second temperature sensor, and said temperature controller is configured to generate an upper limit for said control command in response to at least said second system diagnosis signal.
